(19) United States
(12) Patent Application Publication
(10) Pub. No.: US 2008/0173195 A1
(43) Pub. Date: Jul. 24, 2008

(54) Offset printing press with cutting register adjustment and corresponding method

(75) Inventors: Francois Vidaillac, Frocourt (FR); Jean-Philippe Lecomte, Senils (FR)

Correspondence Address: Davidson, Davidson & Kappel, LLC, 485 7th Avenue, 14th Floor, New York, NY, 10018, US

(73) Assignee: GOSS INTERNATIONAL MONTATAIRE SA, Montataire (FR)

(21) Appl. No.: 12/004,159

(22) Filed: Dec. 20, 2007

(30) Foreign Application Priority Data
Dec. 26, 2006 (FR) 06 11380

(51) Int. Cl. B41F 9/00; B41F 13/56

(52) U.S. Cl. 101/142; 101/227

(57) ABSTRACT

An offset printing press is provided, including at least one unit for printing a web of paper, a device for transversely cutting the web of paper arranged downstream of the printing unit, and at least one system for controlling the printing unit.

The control system is suitable for controlling, when the web of paper is moving, the implementation of steps involving:

a) moving the printing unit into a throw-off configuration, the web of paper moving in the space delimited between the blanket cylinders,

b) slowing down or accelerating the plate cylinder in order to modify the adjustment of the cutting register between the printing unit and the cutting device,

c) moving the printing unit into a throw-on configuration.

This claims the benefit of French Application 06 11380 filed on Dec. 26, 2006, the entire specification of which is hereby incorporated by reference herein.

The present invention relates to an offset printing press of the type comprising at least one unit for printing a web of paper, a device for transversely cutting the web of paper arranged downstream of the printing unit, and at least one system for controlling the printing unit.

### BACKGROUND TO THE INVENTION

The invention is used in particular for presses which are referred to as “shaftless”, that is to say, in which the driving of the printing units is carried out by means of independent respective electric motors which are mutually synchronised.

An arrangement of this type allows the common motor and the longitudinal mechanical coupling shaft between the printing units that were used in the prior art to be dispensed with.

In a press of this type, the cutting device, which conventionally belongs to a folding device, is also provided with an independent respective electric motor.

Presses of this type are known in particular from documents GB-2 149 149 and EP-699 524.

As indicated in these documents, shaftless presses also have advantages linked with adjustments of the registers and in particular with the adjustment of the cutting register. This adjustment can be carried out without the full-width compensators which were generally interposed between the printing units and the folding device.

Since these full-width compensators are dispensed with, the adjustment of the cutting register, that is to say, the position of the transverse cut relative to the images printed successively on the web, is carried out not by modifying the length of the web between the downstream printing unit and the folding device, but instead by modifying the angular positions of the plate cylinders of the printing units.

In this manner, during the pre-adjustment of the press prior to carrying out a printing operation, each plate cylinder is brought into a predetermined angular position which allows the desired cutting register to be achieved and therefore ensures that the transverse cut is made at the correct longitudinal location between all the images which are successively printed on the web of paper by the printing units.

In these documents, the cutting register errors are also corrected which can be detected when the press is operational and the web of paper is therefore moving.

### SUMMARY OF THE INVENTION

To this end, the plate cylinders of the printing units are slowed or accelerated while the web of paper is squeezed between their blanket cylinders and the corresponding pressure cylinders.

However, such a correction is slow, with the result that a great quantity of paper may be wasted.

In this manner, such a correction of the cutting register may take several minutes if the extent of the correction to be carried out is significant.

This may, for example, be the case when the path of the paper web is changed downstream of the printing groups.

An object of the invention provides a press which allows the adjustment of the cutting register to be modified while limiting the quantity of paper wasted.

To this end, the invention provides a printing press wherein the control system is suitable for controlling, when the web of paper is moving, the implementation of steps including:

a) moving the printing unit into a throw-off configuration, the web of paper moving in the space delimited between the blanket cylinders,

b) slowing down or accelerating the plate cylinder in order to modify the adjustment of the cutting register between the printing unit and the cutting device, and

c) moving the printing unit into a throw-on configuration.

According to specific embodiments, the press may include one or more of the following features, taken in isolation or according to any technically possible combination:

the control system may be capable of comparing the extent of a modification of the adjustment of the cutting register to be carried out with a threshold value and controlling, when the web of paper is moving, and in accordance with the result of the comparison, either the implementation of the steps a), b) and c) or the implementation of the step b),

the press may include at least one sensor for detecting reference marks which are printed on the web by the printing unit and the control system is suitable for determining, from a signal provided by the detection sensor, a modification of the adjustment of the cutting register to be carried out,

the control system may include a device for entering a modification of the adjustment of the cutting register to be carried out,

the pressure cylinder may be formed by the blanket cylinder of another printing group of the printing unit,

the printing unit may include an inking system and a wetting system, and the control system may be suitable for controlling the implementation:

between the steps a) and b), of a step a1) for deactivating the inking system and wetting system, and,

between the steps b) and c), of a step b1) for reactivating the inking system and wetting system;

each printing unit may include at least one respective electric drive motor which is separate from the drive motor of the cutting device;

in the throw-off configuration, the space may be suitable for allowing the web to move freely without touching the blanket cylinders; and

the cutting device may belong to a folding device.

The invention also has a method for modifying the cutting register of a printing press, wherein the printing press is a press as defined above and the method includes the steps of:

a) moving the printing unit into a throw-off configuration, the web of paper moving in the space delimited between the blanket cylinders,

b) slowing down or accelerating the plate cylinder in order to modify the adjustment of the cutting register between the printing unit and the cutting device, and

c) moving the printing unit into a throw-on configuration.

According to specific embodiments, the method may include one or more of the following features, taken in isolation or according to any technically possible combination:

the method may include a previous step for comparing the extent of a modification of the adjustment of the cutting register to be carried out with a threshold value and controlling, when the web of paper is moving, and in accordance with the result of the comparison, either the implementation of the steps a), b) and c) or the implementation of the step b); and

the printing unit of the printing press may include an inking system and a wetting system, and the method may include:

between the steps a) and b), a step a1) for deactivating the inking system and wetting system, and

between the steps b) and c), a step b1) for reactivating the inking system and wetting system.

### BRIEF DESCRIPTION OF THE DRAWINGS

The invention will be better understood from a reading of the following description, given purely by way of example and with reference to the appended drawings, in which:

FIG. 1 is a schematic view of an offset printing press according to the invention,

FIG. 2 is a schematic view of a printing unit of the press of FIG. 1, the printing unit being in a throw-on configuration,

FIG. 3 is a view similar to FIG. 2, the printing unit being in a throw-off configuration, and

FIG. 4 is a flow chart illustrating the steps of a method for correcting the cutting register implemented by the press of FIG. 1.

### DESCRIPTION OF PREFERRED EMBODIMENTS

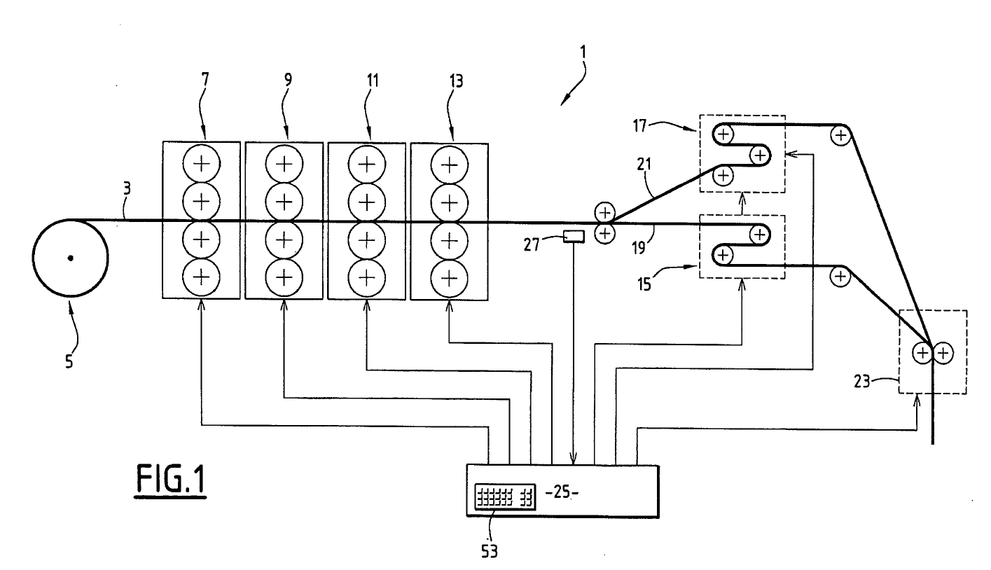

FIG. 1 illustrates an offset printing press 1 which principally includes, successively in the movement direction of the web 3, an unrolling device 5, printing units 7, 9, 11 and 13, partial-width compensators 15 and 17 for adjusting the respective cutting registers of strips 19 and 21 cut longitudinally from the strip 3, and a folding device 23.

In the example illustrated, the press 1 does not include dryer/cooling means, but such means may be provided in some variants.

Also in some variants, the press 1 may not include partial-width compensators 15 and 17.

Also in the example illustrated, the press 1 includes four printing units 7, 9, 11 and 13 but this number may be different, in particular if the press is a press referred to as an Auto Transfer press (Registered Trademark).

It should be noted that, in a press of this type, some printing units may carry out a printing operation, while others may be prepared for a subsequent printing operation.

The cylinders of the printing units 7, 9, 11 and 13, the compensators 19 and 21 and the folding device 23 which are in contact with the web 3 and which are motor-driven, drive the web of paper 3 so that it moves from the unrolling device 5 as far as the folding device 23.

The press may also include other devices for driving the web 3, such as rollers.

All the operational elements described above, and in particular the printing units 7, 9, 11 and 13, are controlled by a computerised control system 25 which is, on the one hand, connected to these various operational elements and which is, on the other hand, connected to a sensor 27 in the example illustrated. This sensor 27 is a sensor for detecting reference marks which are printed on the web 3 by the units 7, 9, 11 and 13 in order to adjust the registers, as will be described below.

In some variants, the press 1 may not include a sensor 27.

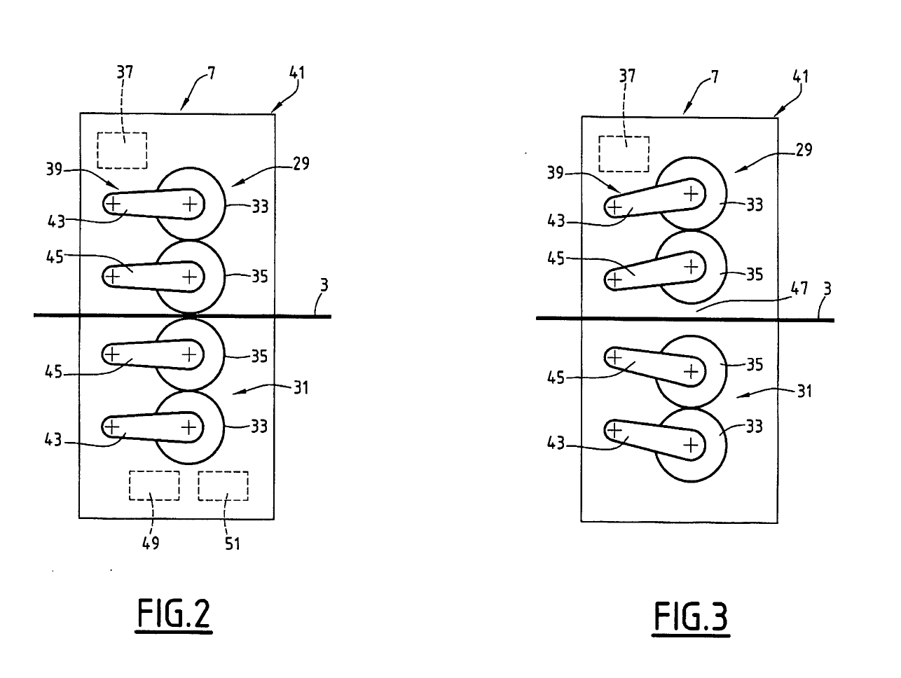

The structures of the printing units of the units 7, 9, 11 and 13 are similar and only that of the unit 7 will be described below with reference to FIGS. 2 and 3.

The printing unit 7 includes two printing groups, that is to say, an upper printing group 29 and a lower printing group 31. Each group 29, 31 includes a plate cylinder 33 which may carry one or more plates and a blanket cylinder 35 which may carry one or more blankets. The blanket cylinder 35 of the lower printing group 31 acts as a pressure cylinder for the upper printing group 29 and vice-versa. The printing unit 7 is therefore a blanket-to-blanket printing unit.

Preferably, the press 1 is a shaftless press, that is to say that all the printing units 7, 9, 11 and 13 and the folding device 23 each have at least one respective and independent electric drive motor 37.

In this manner, each printing unit may have a single respective electric motor which drives the two printing groups 29 and 31. It is also possible to provide a respective drive motor for each printing group 29 and 31. In this instance, for each printing group, the motor may, for example, drive the blanket cylinder 35 by means of the plate cylinder 33 of the printing group in question.

It is further possible to provide a respective drive motor for each cylinder 33, 35 of each printing group 29, 31.

More generally, all the methods for driving the printing units used in shaftless presses may be used in this instance.

The printing unit 7 of the FIGS. 2 and 3 includes a mechanism 39 for supporting and moving the cylinders 33 and 35, which mechanism 39 is carried by the frame 41 of the unit 7. Typically, this frame 41 includes two lateral walls between which the plate cylinder 33 and the blanket cylinder 35 are arranged.

In the example illustrated, the movement mechanism 39 includes arms 43 for receiving the plate cylinders 33 and arms 45 for receiving the blanket cylinders 35. An arm 43 is arranged at each end of a cylinder 33 and an arm 45 is arranged at each end of a cylinder 35. The cylinders 33 and 35 may pivot in the arms 43 and 45 around their axes in the arms 43 and 45.

The arms 43 and 45 are articulated to the frame 41 in order to allow them to pivot relative to the frame parallel with the axes of the plate cylinder 33 and blanket cylinder 35.

Furthermore, the support and movement mechanism 39 includes actuators, for example, pneumatic jacks, which allow the arms 43 and 45 to be manoeuvred.

Owing to the support and movement mechanism 39, the printing unit 7 has a throw-on configuration illustrated in FIG. 2 and at least one throw-off configuration illustrated in FIG. 3.

In the throw-on configuration, the plate cylinder 33 and blanket cylinder 35 are pressed one against the other and the web of paper 3 may therefore be squeezed between the two blanket cylinders 35 in order to be printed.

In the throw-off configuration, the printing groups 29 and 31 have been moved so that the blanket cylinders 35 are mutually spaced-apart and together delimit a space 47 in which the web 3 may pass freely. In some variants, this space 47 is sufficiently large for the web 3 to be able to move without touching the blanket cylinders 35. However, it will be noted that this feature is not required.

In order to achieve this configuration, the upper arms 43 and 45 have, for example, pivoted upwards and the lower arms 43 and 45 have, for example, pivoted downwards.

In the throw-off configuration illustrated, the plate cylinder 33 and the blanket cylinder 35 of the same printing group are in contact with each other, but this is not necessarily the case. In this manner, the printing unit 7 may also have, in addition to or in place of the throw-off configuration of FIG. 3, throw-off configurations in which the plate cylinder 33 and blanket cylinder 35 of the groups 29 and 31 are mutually spaced-apart. In the same manner, the mechanism 39 for supporting and moving the cylinders 33 and 35 may have a different structure from that described above and may, for example, allow movement from one configuration to the other with only some of the cylinders being displaced.

Also in conventional manner, an inking system 49 and a wetting system 51 are associated with each printing group 29,3 31. For reasons of simplification, such systems 49 and 51 have been illustrated only for the lower printing group 31 in FIG. 2.

All the operating equipment of a printing unit, such as the inking system 49, wetting system 51, the support and movement mechanism 39 and the drive motor(s) 37 are controlled by the control system 25.

In conventional manner, during the printing operation, the units 7, 9, 11 and 13 are in a throw-on configuration. The cylinders of the printing groups 29 and 31 are rotatably driven about their respective axes and the web 3 is moved. The plates carried by the plate cylinders 33 of the printing units 7, 9, 11 and 13 are wetted, then inked by the inking system 49 and wetting system 51. These plates apply the ink from their printing regions to the blankets carried by the cylinders 35 which in turn apply the ink to the web 3 which is thus printed on the two sides thereof. In this manner, the blanket cylinders 35 each successively print, owing to their rotation about their respective axes, the same image on the web 3.

After the printing unit 13, the web of paper 3 is cut longitudinally in order to form strips 19 and 21 having partial widths. These strips 19 and 21 are, in the example illustrated, superimposed and cut transversely in the folding device 23 between the successive images printed on the web 3.

During printing, the sensor 27 transmits signals for detecting reference marks printed on the web 3 by the units 7, 9, 11 and 13. From these signals, and in conventional manner, the control system 25 detects any cutting register and circumferential register errors, that is to say, the longitudinal component of the colors register. The system 25 corrects these register errors by increasing or decreasing the drive speeds of the plate cylinders 33 of the cylinders of the units 7, 9, 11 and 13.

The system 25 therefore implements loops for adjusting the cutting and circumferential registers.

The compensators 15 and 17 further allow the cutting register to be adjusted for each of the strips 19 and 21. These registers may not be adjusted independently of each other by the cylinders of the printing units 7, 9 11 and 13 being rotated.

While the web 3 is moving, it is possible, following a change of operation, that is to say, products to be printed, or path of the web 3, that a correction of the cutting register may be necessary.

FIG. 1 illustrates a single path of the web of paper 3. In practice, however, the press 1 may include, in addition to the folding device 23, other cutting devices or additional modules, such as a perforation group or a retouching group, etcetera.

The web 3 may thus select in conventional manner one of many paths in accordance with the elements to be passed through or bypassed.

If the path of the web 3 is modified, the correction of the cutting register to be carried out may be great. This correction will be carried out by temporarily slowing down or accelerating the plate cylinders 33 of the printing units 7, 9, 11 and 13.

The operator may also be caused to initiate a modification of the adjustment of the cutting register by accelerating or slowing down the cylinders of the printing units 7, 9, 11 and 13, for example, if he visually detects a register error.

In each of these two examples, and in order to initiate the modification of the adjustment of the cutting register, the operator activates a device for entering the modification of cutting register to be carried out, for example, a button of a console 53 of the system 25.

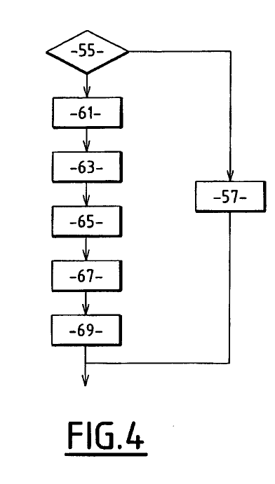

The system 25 controls the implementation of the method illustrated by the flow chart of FIG. 4.

In a first step 55, the extent of the modification requested is compared with a threshold value. If the extent of the modification requested is less than this threshold value, the step 57 is carried out.

It is a conventional step for modification of the cutting register, carried out by accelerating or slowing down the cylinders of the printing units 7, 9, 11 to 13 and in particular the plate cylinders 33. The web of paper 3 is therefore still squeezed between the blanket cylinders 35 and continues to move, as during the printing operation.

If, in contrast, the extent of the modification requested is greater than the threshold value, which will, for example, be the case when the web 3 changes path, the steps 61, 63, 65, 67 and 69 are carried out.

At step 61, the loops for adjustment of the cutting register and circumferential register are deactivated.

At step 63, the inking system 49 and wetting system 51 are deactivated, then the printing units 7, 9, 11 and 13 move into a throw-off configuration. The web of paper 3 is therefore no longer squeezed between the blanket cylinders 35.

At step 65, the correction of the cutting register is carried out by means of slowing down or accelerating the cylinders of the printing units and in particular the plate cylinders 33. Since the web 3 is no longer in contact with the blanket cylinders 35, this slowing or acceleration has no effect on the web of paper 3. The slowing or acceleration may be much greater than in step 57 or in the prior art, but without the risk of breaking the web 3 or without the risk of bringing about a blockage in the folding device 23. The step 65 for modification of the cutting register itself may therefore be very short, even for a modification of great magnitude.

At step 67, the printing units 7, 9, 11 and 13 are returned to the throw-on configuration and the inking system 49 and wetting system 51 are reactivated.

At step 69, the loops for controlling the various registers are reactivated.

In this manner, when a significant correction of the cutting register is requested, this correction is carried out while the printing units are in a throw-off configuration, which allows the period of time required to carry out this correction to be reduced and which therefore limits the wastage of paper.

A method of this type may advantageously be implemented on presses 1 which are not suitable for carrying out a pre-adjustment of the cutting register and/or which do not adjust the cutting register.

Generally, steps 63 and 67 do not necessarily involve the activation and the deactivation of the inking system 49 and wetting system 51.

In the same manner, the printing units do not necessarily have the structure described above and may include a number of printing groups different from that described above, optionally arranged around a central and common printing cylinder. These may be Y-shaped, U-shaped or H-shaped structures.

Generally, the folding device 23 may be replaced, for example, by a simple cutting device.

Furthermore, the extent of a cutting register correction to be carried out may be, in some variants, automatically determined from a signal provided by the sensor 27.

What is claimed is:

1-12. (canceled)

13. An offset printing press comprising at least one unit for printing a web of paper, a device for transversely cutting the web of paper arranged downstream of the printing unit, and at least one system for controlling the printing unit, the printing unit comprising:
a frame;
at least one printing group comprising a plate cylinder and a blanket cylinder to co-operate with a pressure cylinder; and
a mechanism for supporting and moving the blanket and pressure cylinders, so the printing unit has at least one throw-on configuration in which the blanket cylinder and the pressure cylinder are pressed against each other, and a throw-off configuration in which the blanket cylinder and the pressure cylinder are mutually spaced-apart and together delimit a space;
the control system controlling, when the web of paper is moving,:
a) moving the printing unit into a throw-off configuration, the web of paper moving in the space delimited between the blanket cylinder and the pressure cylinder,
b) slowing down or accelerating the plate cylinder in order to modify an adjustment of a cutting register between the printing unit and the cutting device,
c) moving the printing unit into a throw-on configuration.

14. The offset printing press as recited in claim 13 wherein the control system is capable of comparing the extent of a modification of the adjustment of the cutting register to be carried out with a threshold value and controlling, when the web of paper is moving, and in accordance with the result of the comparison, at least the slowing down or accelerating step.

15. The offset printing press as recited in claim 13 further comprising at least one sensor for detecting reference marks which are printed on the web by the printing unit, the control system being suitable for determining, from a signal provided by the detection sensor, a modification of the adjustment of the cutting register to be carried out.

16. The offset printing press as recited in claim 13 wherein the control system comprises a device for entering a modification of the adjustment of the cutting register to be carried out.

17. The offset printing press as recited in claim 13 wherein the pressure cylinder is the blanket cylinder of another printing group of the printing unit.

18. The offset printing press as recited in claim 13 wherein each printing unit comprises an inking system and a wetting system, and wherein the control system is able to control:
deactivating the inking system and wetting system, after moving the printing unit into a throw-off configuration and before slowing down or accelerating the plate cylinder and,
reactivating the inking system and wetting system, after slowing down or accelerating the plate cylinder and before moving the printing unit into a throw-on configuration.

19. The offset printing press as recited in claim 13 wherein each printing unit further comprises at least one respective electric drive motor separate from a drive motor of the cutting device.

20. The offset printing press as recited in claim 19 wherein, in the throw-off configuration, the space is suitable for allowing the web to move freely without touching the blanket cylinder and the pressure cylinder.

21. The offset printing press as recited in claim 13 wherein, in the throw-off configuration, the space is suitable for allowing the web to move freely without touching the blanket cylinder and the pressure cylinder.

22. The offset printing press as recited in claim 13 further comprising a folding device, the folding device including the cutting device.

23. A method for modifying the cutting register of the printing press as recited in claim 1 comprising the steps of:
a) moving the printing unit into a throw-off configuration, the web of paper moving in the space delimited between the blanket cylinder and the pressure cylinder,
b) slowing down or accelerating the plate cylinder in order to modify the adjustment of the cutting register between the printing unit and the cutting device,
c) moving the printing unit into a throw-on configuration.

24. The method as recited in claim 23 further comprising the step of comparing the extent of a modification of the adjustment of the cutting register to be carried out with a threshold value, in order to control, while the web of paper is moving, and in accordance with the result of the comparison, performing at least the slowing down or accelerating step.

25. The method as recited in claim 23 further comprising the steps of:
deactivating an inking system and wetting system of each printing unit in the printing press after moving the printing unit into a throw-off configuration and before slowing down or accelerating the plate cylinder, and
reactivating the inking system and wetting system of each printing unit in the printing press after slowing down or accelerating the plate cylinder and before moving the printing unit into a throw-on configuration.
